(19) United States
(12) Patent Application Publication
(10) Pub. No.: US 2022/0127881 A1
(43) Pub. Date: Apr. 28, 2022

(54) Sliding Door Brace Apparatus

(71) Applicant: Brice McCain, Port Orchard, WA (US)

(72) Inventor: Brice McCain, Port Orchard, WA (US)

(21) Appl. No.: 17/080,039

(22) Filed: Oct. 26, 2020

(51) Int. Cl. E05B 65/08; E05C 19/00

(52) U.S. Cl. CPC E05B 65/0888; E05C 19/003

(57) ABSTRACT

A sliding door brace apparatus for creating a strong seal on a sliding glass door includes a fixed clamp having a receiving channel to receive an outer frame of a sliding door and a set screw extending into the receiving channel. An extension arm is coupled to the fixed clamp. A rail has a proximal end coupled to the extension arm and a distal end. A slider is coupled to the rail and a trigger is coupled to the slider to ratchet the slider towards the distal end of the rail. A release button is coupled to the slider to allow the slider to move towards the proximal end of the rail. A door wedge is coupled to the slider to engage a panel frame of the sliding door.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to sliding door brace devices and more particularly pertains to a new sliding door brace device for creating a strong seal on a sliding glass door.

### (2) Description of Related Art Including Information Disclosed Under 37 CFR 1.97 and 1.98

The prior art relates to sliding door brace devices. Known devices typically pivot to create leverage. These devices also do not include a fixed clamp end and a magnetic end which may both remain in contact with the sliding door at all times, even while being opened. Known devices lack an internal ratchet system with a pull trigger and release button to increase tension and release tension, respectively.

### BRIEF SUMMARY OF THE INVENTION

An embodiment of the disclosure meets the needs presented above by generally comprising a fixed clamp having a receiving channel configured to receive an outer frame of a sliding door and a set screw extending into the receiving channel. An extension arm is coupled to the fixed clamp. A rail has a proximal end coupled to the extension arm and a distal end. A slider is coupled to the rail. The slider has a rail aperture extending therethrough. The rail aperture has an internal ratcheting mechanism receiving the rail. A trigger is coupled to the slider. The trigger is in operational communication with the internal ratcheting mechanism of the slider to advance the slider towards the distal end of the rail. A release button is coupled to the slider. The release button is in operational communication with the internal ratcheting mechanism of the slider to allow the slider to move towards the proximal end of the rail. A door wedge is coupled to the slider. The door wedge has a plate portion configured to engage a panel frame of the sliding door.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a sliding door brace apparatus according to an embodiment of the disclosure.

FIG. 2 is a front elevation view of an embodiment of the disclosure.

FIG. 3 is a bottom plan view of an embodiment of the disclosure.

FIG. 4 is a rear elevation view of an embodiment of the disclosure.

FIG. 5 is an in-use view of an embodiment of the disclosure.

### DETAILED DESCRIPTION OF THE INVENTION

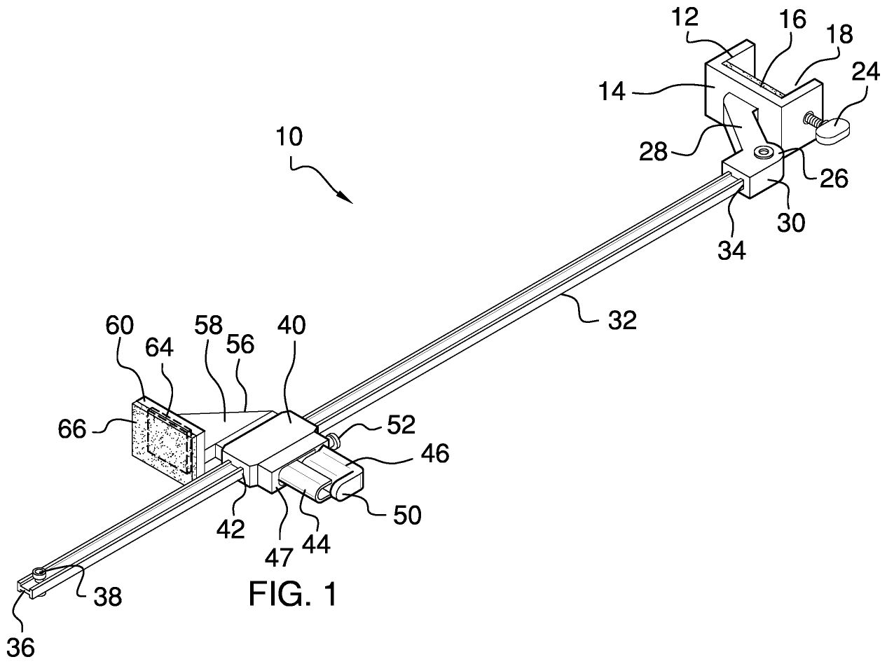

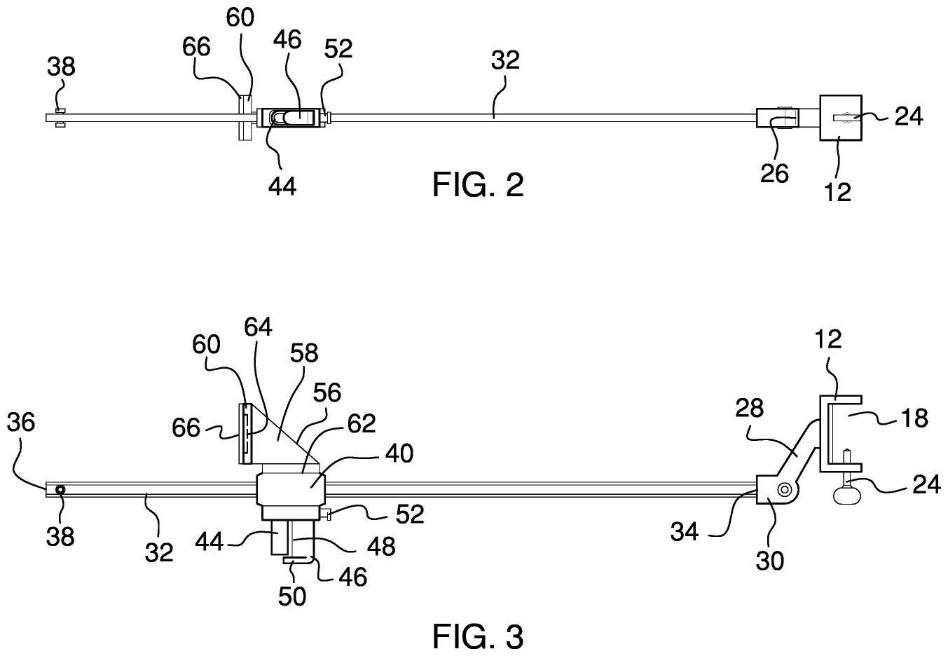

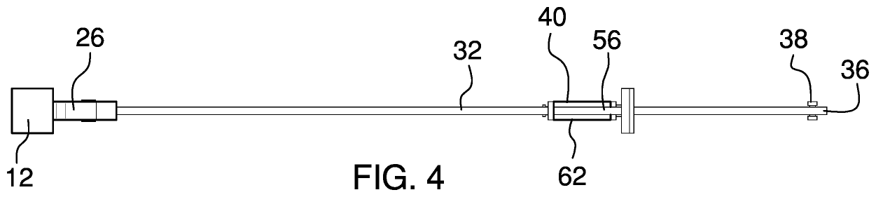

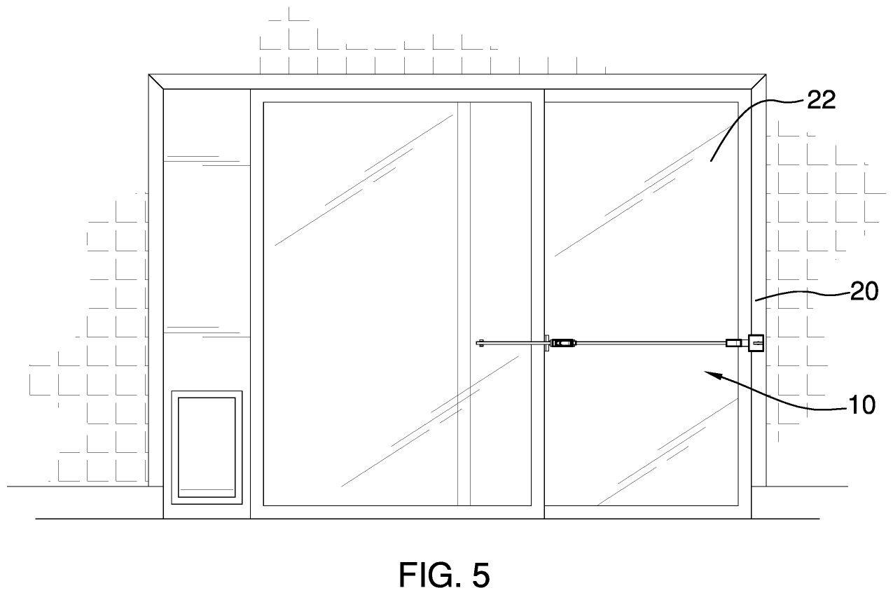

With reference now to the drawings, and in particular to FIGS. 1 through 5 thereof, a new sliding door brace device embodying the principles and concepts of an embodiment of the disclosure and generally designated by the reference numeral 10 will be described.

As best illustrated in FIGS. 1 through 5, the sliding door brace apparatus 10 generally comprises a fixed clamp 12. The fixed clamp 12 may be a squared U-shape. A medial face 14 of the fixed clamp may have a clamp pad 16. The fixed clamp 12 has a receiving channel 18 configured to receive an outer frame 20 of a sliding door 22 and a set screw 24 extending into the receiving channel 18. The clamp pad 16 protects the outer frame 20 from damage. The set screw 24 may be tightened to secure the fixed clamp 12 to the outer frame 20.

An extension arm 26 is coupled to the fixed clamp 12. The extension arm 26 may have an angled portion 28 and a receiver portion 30. A rail 32 is coupled to the extension arm 26 and has a proximal end 34 and a distal end 36. The proximal end 34 is coupled to the receiver portion 30 with the rail 32 extending along an axis perpendicular to the medial face 14 of the fixed clamp. The rail 32 may have an H-shaped profile and a stopper 38 proximal the distal end 36.

A slider 40 is coupled to the rail 32. The slider 40 has a rail aperture 42 extending therethrough and an internal ratcheting mechanism receiving the rail 32. A trigger 44 is coupled to the slider 40. The trigger 44 may have a U-shaped profile. The trigger 44 is in operational communication with the internal ratcheting mechanism of the slider to advance the slider 40 towards the distal end 36 of the rail.

A handle 46 may be coupled to a left side 47 of the slider. The handle 46 is coupled adjacent the trigger 44. The handle 46 may have a rounded front face portion 48 to selectively receive the trigger 44. The handle 46 provides a leverage point for the user's hand while repeatedly squeezing and releasing the trigger 44 to advance the slider 40. The handle 46 may have a safety portion 50 extending past the front face portion 48 to prevent pinching with the trigger 44. A release button 52 is coupled to the slider 40. The release button 52 may be coupled to a back side 54 of the slider and is in operational communication with the internal ratcheting mechanism of the slider 40 to allow the slider 40 to move towards the proximal end 34 of the rail.

A door wedge 56 is coupled to the slider 40. The door wedge 56 may have a triangular brace portion 58 and a plate portion 60 coupled to the brace portion 58. The brace portion 58 may extend from a right side 62 of the slider and the plate portion 60 lies in a plane parallel to a plane of the medial face 14 of the fixed clamp. A magnet 64 may be coupled within the plate portion 60 and a wedge pad 66 may be coupled to the plate portion 60. The plate portion 60 is configured to engage a panel frame 68 of the sliding door. The magnet 64 helps prevent slippage against the panel frame 68 and the wedge pad 66 helps prevent damage to the panel frame 68.

In use, the apparatus 10 is used to enhance the sliding door 22 either as a locking mechanism or to create a seal between the panel frame 68 and a door insert 70 having a pet door 72. The fixed clamp 12 is engaged with the outer frame 20 and the door wedge 56 is placed against the panel frame 68. Then trigger 44 is then pulled to increase force against the panel frame 68 as the slider 40 advances.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A sliding door brace apparatus comprising:
a fixed clamp, the fixed clamp having a receiving channel configured to receive an outer frame of a sliding door and a set screw extending into the receiving channel;
an extension arm coupled to the fixed clamp;
a rail coupled to the extension arm, the rail having a proximal end coupled to the extension arm and a distal end;
a slider coupled to the rail, the slider having a rail aperture extending therethrough, the rail aperture having an internal ratcheting mechanism receiving the rail;
a trigger coupled to the slider, the trigger being in operational communication with the internal ratcheting mechanism of the slider to advance the slider towards the distal end of the rail;
a release button coupled to the slider, the release button being in operational communication with the internal ratcheting mechanism of the slider to allow the slider to move towards the proximal end of the rail; and
a door wedge coupled to the slider, the door wedge having a plate portion configured to engage a panel frame of the sliding door.

2. The sliding door brace apparatus of claim 1 further comprising a handle coupled to a left side of the slider, the trigger being coupled adjacent the handle.

3. The sliding door brace apparatus of claim 2 further comprising the trigger having a U-shaped profile, the handle having a rounded front face portion to selectively receive the trigger.

4. The sliding door brace apparatus of claim 1 further comprising the fixed clamp being a squared U-shape, a medial face of the fixed clamp having a clamp pad.

5. The sliding door brace apparatus of claim 1 further comprising the extension arm having an angled portion and a receiver portion, the proximal end of the rail being coupled to the receiver portion and extending along an axis perpendicular to a medial face of the fixed clamp.

6. The sliding door brace apparatus of claim 1 further comprising the release button being coupled to a back side of the slider.

7. The sliding door brace apparatus of claim 1 further comprising the door wedge having a triangular brace portion with the plate portion coupled to the brace portion, the plate portion lying in a plane parallel to a plane of a medial face of the fixed clamp.

8. The sliding door brace apparatus of claim 7 further comprising a magnet coupled within the plate portion.

9. The sliding door brace apparatus of claim 7 further comprising a wedge pad coupled to the plate portion.

10. The sliding door brace apparatus of claim 1 further comprising the rail having an H-shaped profile.

11. A sliding door brace apparatus comprising:
a fixed clamp, the fixed clamp being a squared U-shape, a medial face of the fixed clamp having a clamp pad, the fixed clamp having a receiving channel configured to receive an outer frame of a sliding door and a set screw extending into the receiving channel;
an extension arm coupled to the fixed clamp, the extension arm having an angled portion and a receiver portion;
a rail coupled to the extension arm, the rail having a proximal end and a distal end, the proximal end being coupled to the receiver portion with the rail extending along an axis perpendicular to the medial face of the fixed clamp, the rail having an H-shaped profile;
a slider coupled to the rail, the slider having a rail aperture extending therethrough, the rail aperture having an internal ratcheting mechanism receiving the rail;
a trigger coupled to the slider, the trigger having a U-shaped profile, the trigger being in operational communication with the internal ratcheting mechanism of the slider to advance the slider towards the distal end of the rail;
a handle coupled to a left side of the slider, the handle being coupled adjacent the trigger, the handle having a rounded front face portion to selectively receive the trigger;
a release button coupled to the slider, the release button being coupled to a back side of the slider, the release button being in operational communication with the internal ratcheting mechanism of the slider to allow the slider to move towards the proximal end of the rail; and
a door wedge coupled to the slider, the door wedge having a triangular brace portion and a plate portion coupled to the brace portion, the plate portion lying in a plane parallel to a plane of the medial face of the fixed clamp, a magnet being coupled within the plate portion and a wedge pad being coupled to the plate portion, the plate portion being configured to engage a panel frame of the sliding door.
